(19) United States
(12) Patent Application Publication
(10) Pub. No.: US 2004/0059906 A1
(43) Pub. Date: Mar. 25, 2004

(54) System and method for booting by use of a flash memory

(75) Inventors: Chanik Park, Seoul (KR); Songho Yoon, Bucheon-City (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/640,637

(22) Filed: Aug. 14, 2003

(30) Foreign Application Priority Data
Sep. 24, 2002 (KR) 10-2002-0057930

(51) Int. Cl. G06F 9/00

(52) U.S. Cl. 713/2

(57) ABSTRACT

A system to be booted by use of a flash memory and a method of booting the system are described. The system includes a flash memory including a data register, a boot handler code, a bootstrap loader code, a bootstrap code and an OS code, wherein the boot handler code and the bootstrap loader code are loaded into the data register by the flash memory when power is applied to the system; a system memory; and a central processing unit loading the bootstrap loader code in the data register into the system memory by executing the boot handler code and then loading the bootstrap code and the OS code into the system memory by executing the bootstrap loader code. Thus, since a specific control logic or additional memory such as ROM are not required for using the flash memory as a boot memory, time required for design and system costs can be reduced.

### BACKGROUND OF THE INVENTION

This application claims the priority of Korean Patent Application No. 10-2002-0057930 filed on Sep. 24, 2002, in the Korean Intellectual Property Office, the disclosure of which is incorporated herein in its entirety by reference.

1. Field of the Invention

The present invention relates to a system to be booted by the use of a flash memory and a method of booting the system, and more specifically, to a system to be booted by use of a flash memory which performs system booting by means of a power-on auto-read function and a method of booting the system.

2. Description of the Prior Art

In general, the term “booting” means an operation of starting or restarting systems such as computers and personal digital assistants (PDAs), and it is generally performed according to process routines of a basic input/output system (BIOS) stored in a boot memory. The BIOS initializes and inspects each hardware through a power-on self test (POST) operation. If the POST operation is executed normally, a bootstrap loader that is a very small program necessary for system booting is executed to load operating system (OS) software into a system memory. The OS software searches for configuration information on system hardware and software so that the system can be operated normally.

A conventional boot memory has mainly used EPROM, EEPROM and the like. However, there are problems in that it requires considerable time to change the booting program and it also requires an additional PROM programming device such as a ROM writer for writing data. In order to solve these problems, it has been considered that an electrically writable/erasable flash memory may be used as a boot memory.

Further, since the flash memory offering BIOS is comprised of an I/O type memory interface (for transmitting data in block units), it cannot directly execute a boot code. Thus, a control logic for conversion into a general ROM type memory interface (for transmitting data in byte/word units) and an additional memory for temporarily storing data retrieved from the flash memory are required.

Korean Patent Application No. 2002-12356 filed by the present applicant discloses a system to be booted by use of a flash memory and a method of booting the system. Referring to FIG. 10, an embodiment of the system according to the patent application includes a controller 11, a bootstrapper 12, a flash memory 14 and a system memory 16 among which data transmission is performed through a system bus 18. Specifically, the bootstrapper 12 includes a bootstrap loader block and an internal RAM block, and the flash memory 14 is divided into a bootstrap code area, an OS code area and a data code area. When power is on, the bootstrapper 12 that has received a system-reset signal loads the bootstrap code into the internal RAM block. Subsequently, the controller 11 executes the bootstrap code so that the system is operated.

However, such a system still requires a specific hardware controller and memory, such as the bootstrap loader block and the internal RAM block, in order to execute the boot code stored in the flash memory. Therefore, such a system has a disadvantage in that system costs may be increased.

### SUMMARY OF THE INVENTION

The present invention is contemplated to solve the problems in the prior art. Accordingly, it is an exemplary object of the present invention to boot a system without an additional hardware controller or memory.

It is another exemplary object of the present invention to boot a system by means of software using a power-on auto-read function.

In order to achieve the above exemplary objects, the present invention provides a system comprising a data register; a flash memory including a boot handler code and a bootstrap loader code, a bootstrap code and an OS code wherein the boot handler code and the bootstrap loader code are loaded into the data register by the flash memory when power is applied to the system; a system memory; and a central processing unit loading the bootstrap loader code in the data register into the system memory by executing the boot handler code and then loading the bootstrap code and the OS code into the system memory by executing the bootstrap loader code.

Meanwhile, the present invention provides a method of booting a system comprising the steps of:

loading a boot handler code and a bootstrap loader code, which are stored in a flash memory, into a data register of the flash memory when power is applied to the system; and allowing a central processing unit to access the boot handler code and the bootstrap code which have been loaded into the data register, so that the bootstrap loader code is loaded into a system memory by executing the boot handler code and sequentially a bootstrap code and an OS code are loaded into the system memory by executing the bootstrap loader code.

Preferably but not necessarily, the boot handler code and the bootstrap loader code are stored in the flash memory, and the flash memory is a sequential access type flash memory.

In the present invention, taking into consideration that sequential access to the flash memory cannot be done because the central processing unit and the flash memory have different interfaces, the boot handler code and the bootstrap loader code are codes which are prepared by converting a program code which supposes an access to an arbitrary address, into a program code that allows a sequential access.

Furthermore, when power is applied to the system, the boot handler code and the bootstrap loader code support software booting by enabling the central processing unit to sequentially access data in the flash memory without input of commands and addresses.

### BRIEF DESCRIPTION OF THE DRAWINGS

The above and other objects, advantages and features of the present invention will become apparent from the following description of an illustrative, non-limiting embodiment given in conjunction with the accompanying drawings, in which:

FIG. 1 is a view showing a configuration of a system according to an embodiment of the present invention;

FIG. 2 is a view showing movement of data from a sequential access type flash memory to a system memory in an embodiment of the present invention;

FIG. 3 shows an input/output relationship between a central processing unit and the sequential access type flash memory in an embodiment of the present invention;

FIG. 4 is a view illustrating a method of converting an arbitrary access execution code into a sequential access execution code according to an embodiment of the present invention;

FIG. 5 is an operation flowchart illustrating a method of booting the system according to an embodiment of the present invention;

FIG. 6 illustrates a configuration and details of pins of the flash memory employed in an embodiment of the present invention;

FIG. 7 is a block diagram of the flash memory employed in an embodiment of the present invention;

FIG. 8 is a timing chart illustrating a general read operation in the flash memory employed in an embodiment of the present invention;

FIG. 9 is a timing chart illustrating a power-on auto-read operation in the flash memory employed in an embodiment of the present invention; and

FIG. 10 is a view showing a configuration of a system using a conventional sequential access type flash memory as a boot memory.

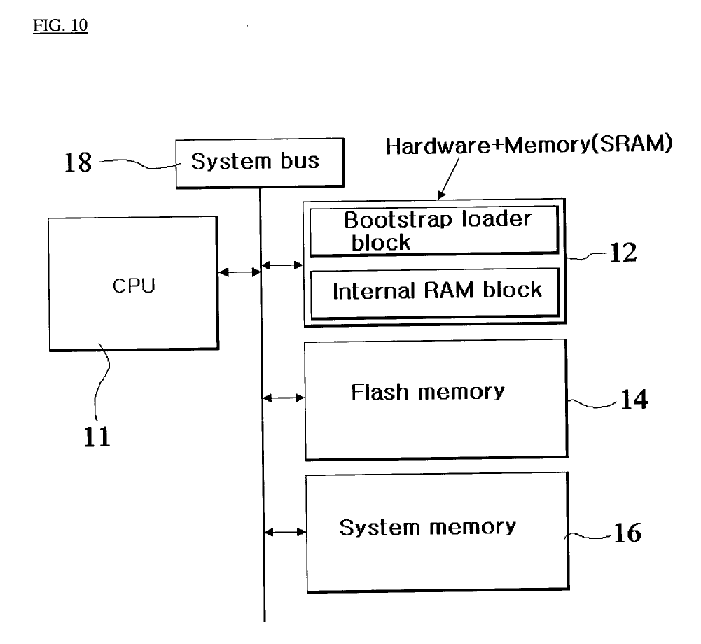

### DETAILED DESCRIPTION OF THE INVENTION

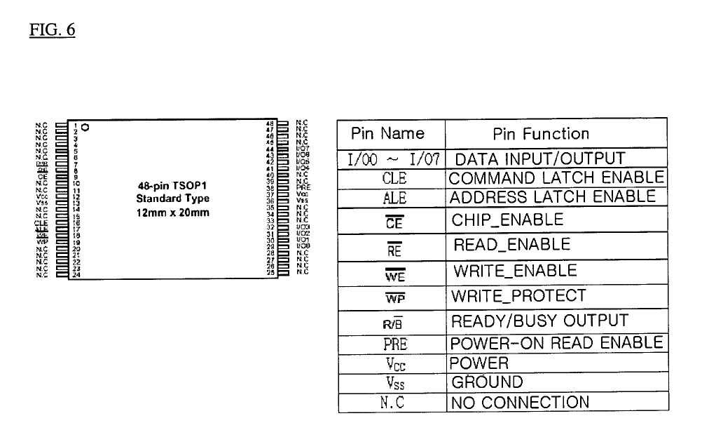

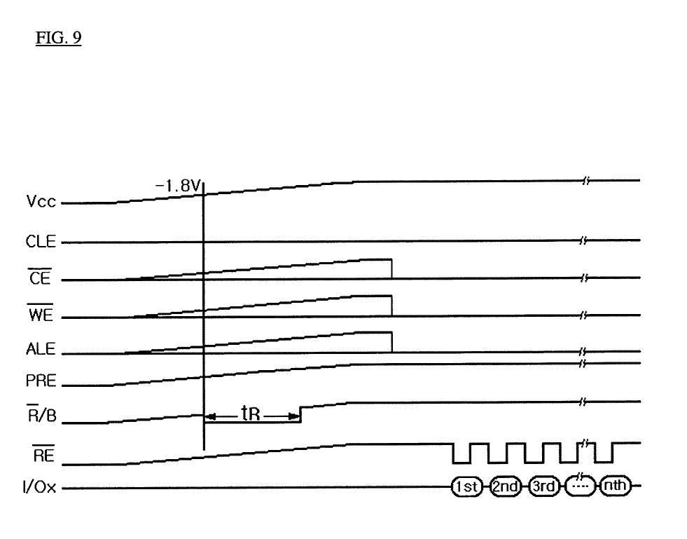

Prior to the description of an illustrative, non-limiting embodiment of the present invention, a pin configuration, functions and a general read operation of a sequential access type flash memory employed in the present invention will be first described with reference to FIGS. 6 to 8. Then, a power-on auto-read operation associated with the booting of a system in the present embodiment will be described with reference to FIG. 9. For reference, a typical sequential access type flash memory is disclosed, for example, in a data book published by Samsung Electronics Co., Ltd. (“128M X 8 bit/64M X 16 bit NAND Flash Memory”, 2002) related to devices having part numbers of K9F1GXXQ0M and K9F1GXXU0M.

FIGS. 6 to 8 are views respectively illustrating a configuration of pins, a functional block diagram and a flowchart illustrating a read operation of an X8 device (K9F1G08X0M) of sequential access type flash memories employed in the present invention, respectively.

In FIG. 6, I/00˜I/07 are used as ports for command input as well as for address and data input/output. Further, a ready/busy signal R/\overline{B} indicates the status of the device operation. When a ready/busy signal R/\overline{B} is low, it indicates that a program, erase or random read operation is in progress. A power-on read enable signal PRE controls an auto-read operation to be executed during power-on.

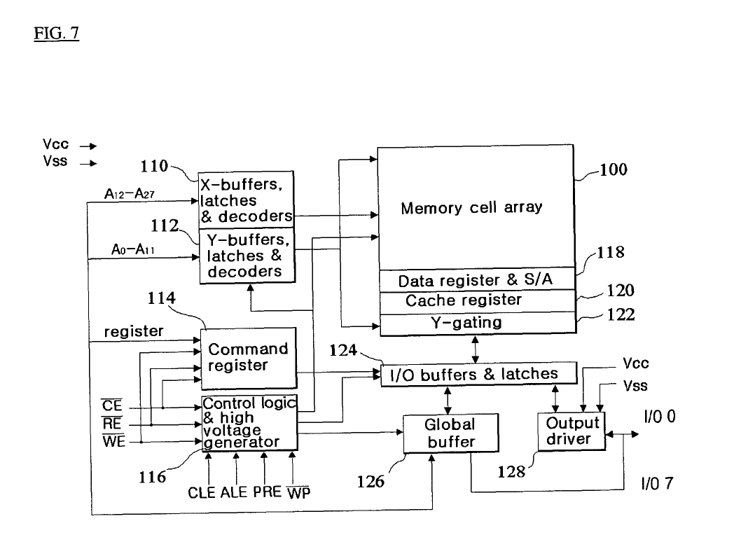

A specific functional block diagram thereof is shown in FIG. 7. As shown in the figure, the sequential access type flash memory includes an electrically erasable and programmable memory cell array 100; X-buffers, latches and decoders 110; Y-buffers, latches and decoders 112; a command register 114; a control logic and high voltage generator 116; a data register and sensing amplifier 118; a cache register 120; and a Y-gating 122. In addition, it further includes I/O buffers and latches 124, global buffers 126 and an output driver 128 in connection with the data input/output. The memory cell array 100 has M pages. Although the number of pages of the memory cell array 100 typically depends on design specifications, the X8 device (K9F1G08X0M) is a 1056 Mbit memory and contains 65,536 pages of which each is 2112-bytes in size. Rows of memory cells in the memory cell array 100 (or arbitrary word lines in which the memory cells are connected to one another) are selected by means of address signals supplied from the X-buffers, latches and decoders 110, and columns of the memory cells are selected by means of address signals supplied from the Y-buffers, latches and decoders 112. The read, write, program and erase operations of the flash memory are performed by inputting specific commands into the command register 114. The status of the pins for selection of each mode is as follows.

TABLE 1

| CLE | ALE | \overline{CE} | \overline{WE} | \overline{RE} | \overline{WP} | PRE | Mode | |
|---|---|---|---|---|---|---|---|---|
| H | L | L | 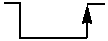 | H | X | X | Read Mode | Command Input |
| L | H | L | 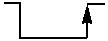 | H | X | X | | Address Input(4clock) |
| H | L | L | 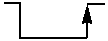 | H | H | X | Write Mode | Command Input |
| L | H | L | 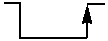 | H | H | X | | Address Input(4clock) |

| | | | | | | | |
|---|---|---|---|---|---|---|---|
| L | L | L | 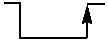 | H | H | X | Data Input |
| L | L | L | H | 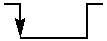 | X | X | Data Output |
| X | X | X | X | H | X | X | During Read(Busy) |
| X | X | X | X | X | H | X | During Program(Busy) |
| X | X | X | X | X | H | X | During Erase(Busy) |
| X | X⁽¹⁾ | X | X | X | L | X | Write Protect |
| X | X | H | X | X | 0V/Vcc⁽²⁾ | 0V/Vcc⁽²⁾ | Stand-by |

NOTE:
⁽¹⁾X can be V_{IL} or V_{IH}
⁽²⁾\overline{WP} and \overline{PRE} should be biased to CMOS high or CMOS low for standby.

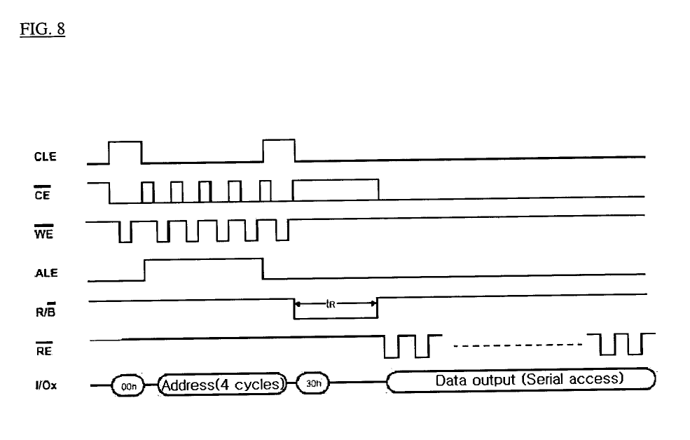

As shown in the table, all of commands, addresses and data can be input when a WRITE_ENABLE \overline{WE} signal is low while a chip enable \overline{CE} signal is low. As shown in FIG. 8, for example, when the device is in a read mode, the read operation is initialized by writing a read command (1 cycle: 00h, 2 cycle: 30h) on the command register (114 of FIG. 7) along with 4 address cycles (column addresses 1 and 2, and row addresses 1 and 2) via an I/O X pin. At this time, data in a selected page is loaded into the data register (118 of FIG. 7) during a data transmission time t_{R} of 25 μs or less. Thereafter, access to the data loaded into the data register 118 is done by sequentially pulsing a READ_ENABLE \overline{RE} signal.

Meanwhile, the flash memory employed in the present invention offers the power-on auto-read function. The power-on auto-read function means a function of enabling a series of data stored in a first page of the flash memory to be accessed without inputting a command and address, contrary to the aforementioned general read operation.

If the power-on auto-read function is set by a user, the auto-read operation is enabled when the Vcc reaches a predetermined voltage (for example, about 1.8V), as shown in FIG. 9. Detection of the voltage is performed by an internal voltage detector (not shown) in the control logic and high voltage generator 116. Furthermore, activation of the auto-read operation is controlled by a power-on auto-READ ENABLE (PRE) signal, and the memory operation is controlled substantially without any intervention of the central processing unit. That is, in accordance with the control of the power-on auto-READ ENABLE (PRE) signal, serial access to the data can be done just after power is turned on. At this time, data in the first page are transmitted to the data register 118 during the data transmission time t_{R}. Thereafter, the data is sequentially read out from the data register 118 by pulsing the READ_ENABLE \overline{RE} signal.

The first page in the present embodiment means the first page of the flash memory, i.e. the page having an address of 0x0000, and the size of the first page is 2112 bytes, for example, when the X8 device (K9F1G08X0M) is used.

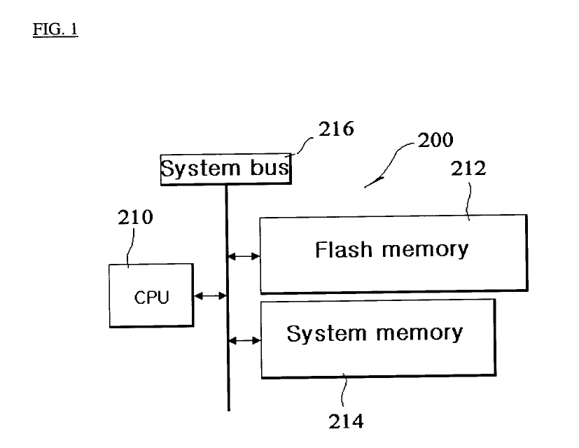

Now, an illustrative, non-limiting embodiment of the present invention will be described in detail with reference to FIGS. 1 to 5 of the accompanying drawings.

As shown in FIG. 1, a system according to the present embodiment, i.e. a system including a flash memory providing the power-on auto-read function 200, comprises a central processing unit 210 for controlling all operations of the system 200, a sequential access type flash memory 212 for performing an auto-read operation, i.e. an operation of loading the data of the first page into a predetermined data register when power is on, and a system memory 214 comprised of a kind of DRAM or SRAM and required for executing boot-related codes stored in the sequential access type flash memory 212. Data transmission is performed through a system bus 216 among the central processing unit 210, the sequential access type flash memory 212 and the system memory 214.

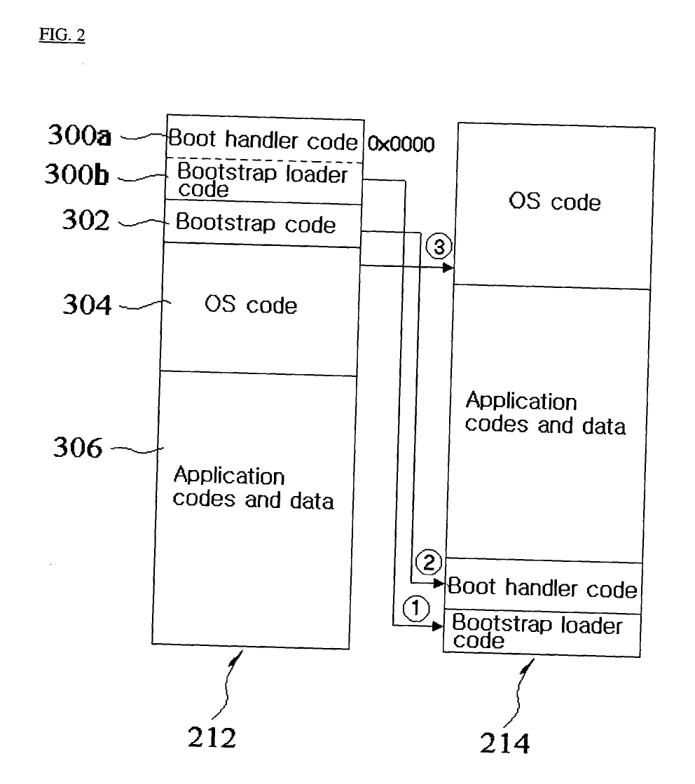

Here, the sequential access type flash memory 212 has a boot handler code 300a and a bootstrap loader code 300b in the first page thereof having addresses beginning at ‘0x0000’ for memory access, as shown in FIG. 2, and stores a bootstrap code 302, an OS code 304 and application programs and user data 306. Particularly, the boot handler code 300a performs a function of copying the bootstrap loader code 300b into a specific area of the system memory 214, and the bootstrap loader code 300b performs a function of loading the actual bootstrap code 302 and the OS code 304 into the system memory 214.

Now, operations of the system 200 will be briefly described. If power is applied to the system 200, data of the first page, i.e. the boot handler code 300a and the bootstrap loader code 300b, are loaded into the data register (118 of FIG. 7) by means of the power-on auto-read function described with reference to FIG. 9. Subsequently, the central processing unit 210 generates a pulsing signal, i.e. READ_ENABLE \overline{RE} signal, receives the boot handler code 300a and executes the code. The bootstrap loader code 300b input into the central processing unit 210 after the execution of the boot handler code 300a is then loaded into the system memory 214. Next, the central processing unit 210 executes the bootstrap loader code 300b, and as a result, the actual bootstrap code 302 is loaded into the system memory 214. If loading of the bootstrap code 302 is completed, hardware is initialized by means of the execution of the bootstrap code 302 in the same manner as a conventional system, and the system 200 is driven by executing the OS code 304.

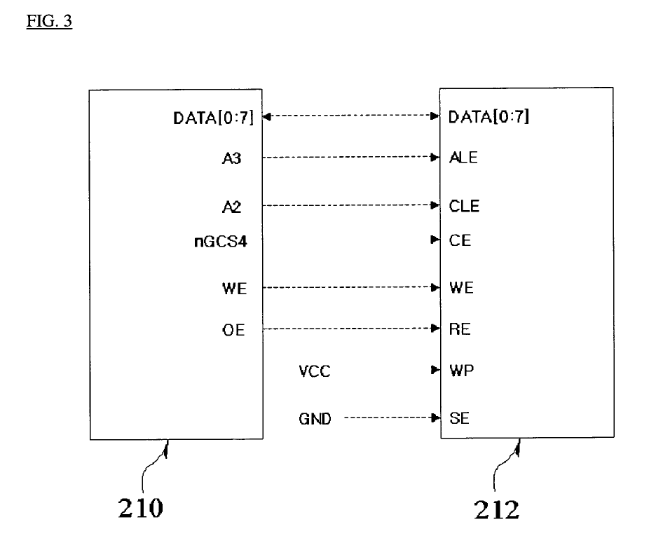

FIG. 3 shows an input/output relationship between the central processing unit and the flash memory. Here, there is a problem in that since the central processing unit 210 has a general ROM type interface and the sequential access type flash memory 212 has an interface by which commands and addresses are multiplexed through I/O pins, the first page of the sequential access type flash memory 212 cannot be accessed arbitrarily when power is applied.

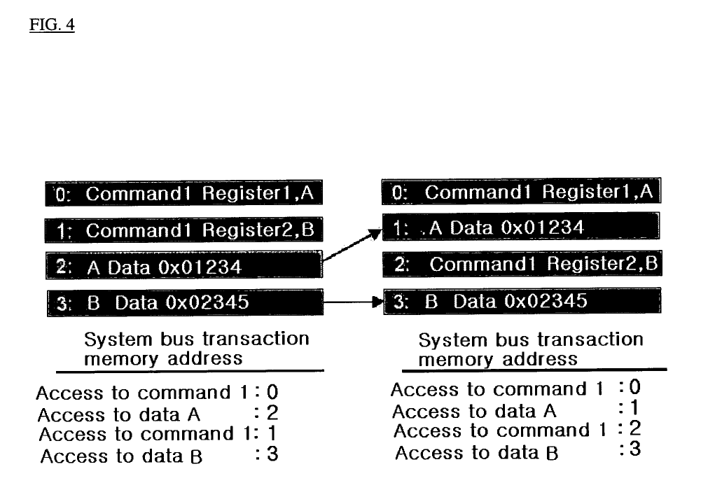

In order to solve this problem, as shown in FIG. 4, the present embodiment prepares the boot handler code 300a and the bootstrap loader code 300b by using a method of converting a program code compiled under the assumption of arbitrary address access into a type of code allowing sequential access. That is, since when the system is booted, only sequential memory access can be done in the sequential access type flash memory 212, commands and data of the boot handler code 300a and the bootstrap loader code 300b are arranged in consideration of this matter.

The upper left portion of FIG. 4 shows that data A are moved to register 1 by means of command 1 and data B are moved to register 2 by means of command 1. From system bus transaction memory addresses shown in the lower left portion of FIG. 4, it can be seen that the addresses are generated arbitrarily. Here, command 1 is a control signal for moving data from the sequential access type flash memory 212 to the data register of the central processing unit 210.

Moreover, the upper right portion of FIG. 4 shows codes reconfigured in consideration of the sequential memory access. Access to data A is done by command 1, and a memory address and the READ_ENABLE \overline{RE} signal are generated. However, since the memory address generated from the central processing unit 210 is ignored at the interface of the sequential access type flash memory 212, data in an address next to the memory address are transmitted to the central processing unit 210 by means of only READ_ENABLE \overline{RE} signal. Therefore, data A desired to be obtained by command 1 is stored in register 1. Then, the central processing unit 210 performs a command fetching operation in order to perform the next command, and as a result, a memory address and a READ_ENABLE \overline{RE} signal related to command 1 are transmitted to the interface of the sequential access type flash memory 212 and command 1 existing in next address 2 is performed irrespective of the memory address so that data B can be stored in register 2. In such a way, although it appears that the central processing unit 210 fetches data from an arbitrary address, values retrieved from sequential addresses through increase of the READ_ENABLE \overline{RE} signal actually become commands and data required by this command. Preferably, such code conversion is performed automatically by use of a code conversion program contained in an operating system such as Windows or a separately prepared code conversion program.

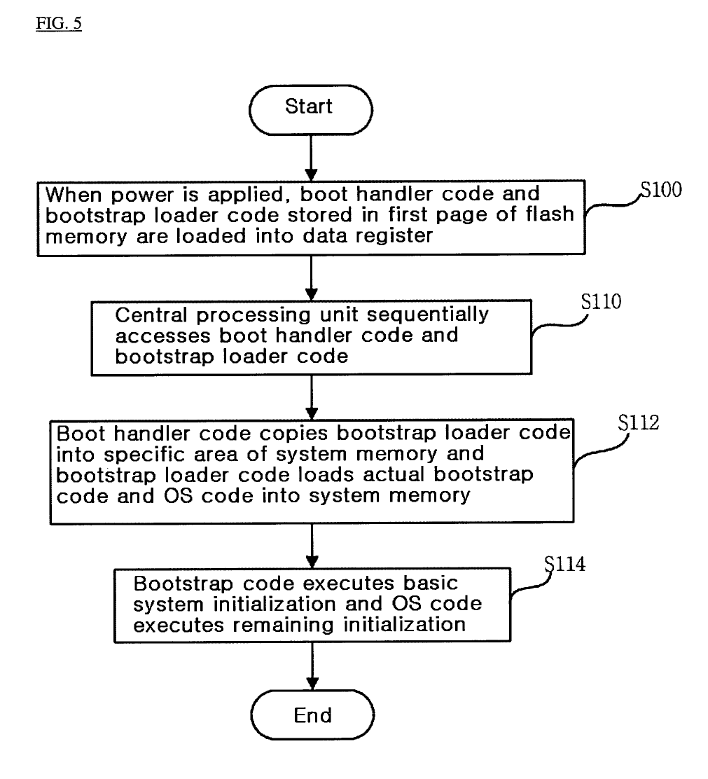

The booting of the system according to the present embodiment is achieved as follows. Referring to FIG. 5, when power is applied to the system 200, a series of data stored in the first page (0x0000) of the sequential access type flash memory 212, i.e. the boot handler code 300a and the bootstrap loader code 300b, are first automatically moved to the data register (118 of FIG. 7) of the sequential access type flash memory 212 (S100).

Then, the central processing unit 210 accesses the boot handler code 300a and the bootstrap loader code 300b loaded into the data register 118 (S110). At this time, data of the data register 118 are sequentially read by means of the READ_ENABLE \overline{RE} signal from the central processing unit 210. Next, the boot handler code 300a copies the bootstrap loader code 300b into a specific area of the system memory 214 and the bootstrap loader code 300b performs a function of loading the bootstrap code 302 and the OS code 304 into the system memory 214 (S112). Finally, the bootstrap code 302 executes basic system initialization and the OS code 304 executes remaining initialization (S114) in accordance with control of the central processing unit 210. Accordingly, booting of the system is completed.

According to an exemplary embodiment of the present invention as described above, since a specific control logic or additional memory such as ROM are not required for using the flash memory as a boot memory, time required for design and system costs can be reduced. As a result, the flash memory can be used as a boot memory in a variety of systems.

The present invention is not limited to the above description of the illustrative embodiment. It will be understood by those skilled in the art that various alternatives, changes, or modifications may be made thereto without departing from the spirit and scope of the invention.

What is claimed is:

1. A system comprising:
a data register;
a flash memory including a boot handler code and a bootstrap loader code, a bootstrap code and an OS code, wherein the boot handler code and the bootstrap loader code are loaded into the data register by the flash memory when power is applied to the system;
a system memory; and
a central processing unit loading the bootstrap loader code in the data register into the system memory by executing the boot handler code and then loading the bootstrap code and the OS code into the system memory by executing the bootstrap loader code.

2. The system as claimed in claim 1, wherein the boot handler code and the bootstrap loader code are stored in a first page of the flash memory.

3. The system as claimed in claim 1, wherein the flash memory is a sequential access type flash memory.

4. The system as claimed in claim 2, wherein the flash memory is a sequential access type flash memory.

5. A method of booting a system comprising the steps of:
loading a boot handler code and a bootstrap loader code, which are stored in a flash memory, into a data register of the flash memory when power is applied to the system; and
allowing a central processing unit to access the boot handler code and the bootstrap code which have been loaded into the data register, so that the bootstrap loader code is loaded into a system memory by executing the boot handler code and sequentially a bootstrap code and an OS code are loaded into the system memory by executing the bootstrap loader code.

6. The method as claimed in claim 5, wherein the boot handler code and the bootstrap loader code are stored in a first page of the flash memory.

7. The method as claimed in claim 5, wherein the flash memory is a sequential access type flash memory.

8. The method as claimed in claim 6, wherein the flash memory is a sequential access type flash memory.
